(19) United States
(12) Patent Application Publication
(10) Pub. No.: US 2026/0330203 A1
(43) Pub. Date: Oct. 22, 2026

(54) APPARATUS, ASSEMBLY, AND SYSTEM FOR OPERATING A HARDWARE-BASED ARTIFICIAL NEURAL NETWORK, AND METHOD FOR TRAINING SAME

(71) Applicant: Fraunhofer-Gesellschaft zur Förderung der angewandten Forschung e.V., Munich (DE)

(72) Inventors: Heiko ZIMMERMANN, Sulzbach (DE); Guenter FUHR, Sulzbach (DE)

(21) Appl. No.: 19/113,805

(22) PCT Filed: Sep. 22, 2023
(86) PCT No.: PCT/EP2023/076243

§ 371 Date: Mar. 20, 2025

(30) Foreign Application Priority Data
Sep. 22, 2022 (EP) 22197087.4

(51) Int. Cl. G06N 3/063

(52) U.S. Cl. CPC G06N 3/063

(57) ABSTRACT

The invention relates to an apparatus for operating a hardware-based artificial neural network, said apparatus comprising at least one hardware-based artificial neural network (11, 24, 32, 41, 51, 71, 81, 101, 111, 121, 131, 171), characterised in that the apparatus comprises at least one interference device (12, 22, 35, 42, 52a, 52b, 72, 82, 102, 112, 122, 132, 172) for coupling at least one interference signal in at least one region of the hardware-based artificial neural network and at least one coupling device (15, 23, 34, 43, 53a, 53b, 73, 83, 103, 113, 123, 133, 173), the coupling device being positioned between the interference device and the hardware-based artificial neural network and being designed to transmit the at least one interference signal from the interference device to the at least one region. The invention also relates to a method for training the apparatus. The invention provides an improved hardware-based artificial neural network which exhibits improved performance.

The invention relates to an apparatus, an arrangement, and a system for operating a hardware-based artificial neural network, and a method for training it.

Artificial intelligence can be used to detect patterns in technical applications, such as image recognition or monitoring machine parameters. Artificial neural networks that mimic the function of biological neurons can provide artificial intelligence. These artificial neural networks can be trained with training data using evolution-based methods, wherein the training adjusts the artificial neural networks so as to improve their ability to perform their tasks. The individual elements of the artificial neural network are re-associated during each training iteration.

In principle, such systems can be implemented as a hardware-based system, i.e. in which the hardware physically forms the network, or as a software-based system, in particular as a virtual network, which is simulated or emulated on a piece of hardware, for example a RAM memory and/or processor. In hardware-based systems, modifiable electronic elements are linked together to form an artificial neural network. Dozens of linked elements can be removed without the system losing its performance. In addition, hardware-based artificial neural networks may have elements that are unconnected to the rest of the network, i. e. unconnected and unused elements that cannot be removed without reducing or losing the performance of the hardware-based artificial neural network.

To reduce this effect, it is known e.g. from Cramer, B., Stöckel, D., Kreft, M., Wibral, M., Schemmel, J., Meier, K., & Priesemann, V. Control of criticality and computation in spiking neuromorphic networks with plasticity, Nature Communications, 11(1) (2020) 2853, to implement the highest possible signal-to-noise ratio between the linked elements, as this allows the number of sub-components to be brought into the thousands and the number of evolutionarily linkable connections into the tens of thousands.

Compared to software-based artificial neural networks, hardware-based artificial neural networks currently have a much more limited number of elements and connections, lower trainability, and lower complexity and flexibility. The object of the invention is therefore to provide an improved hardware-based artificial neural network in which the aforementioned disadvantages are eliminated.

The object is achieved by the features of the independent claims. Advantageous refinements are the subject matter of the dependent claims and the following description.

According to a first aspect, the invention relates to an apparatus for operating a hardware-based artificial neural network, comprising at least one hardware-based artificial neural network, it being provided according to the invention that the apparatus comprises at least one interference device for injecting at least one interference signal into at least one region of the hardware-based artificial neural network and at least one coupling device, the coupling device being positioned between the interference device and the hardware-based artificial neural network and being designed to transmit the at least one interference signal from the interference device to the entirety of the at least one region.

A hardware-based artificial neural network is understood to include both biologically based neural networks, in which the nodes usually have comparable properties (weight, transmission function, etc.) and are arranged in layers, as well as electronic circuits in which the nodes of the network have different digital and/or analog circuit elements, in contrast to biologically based neural networks. These may also not be in the form of layers as in biologically based networks, but instead stochastically connected as an electronic circuit, so that in some of the circuit elements, for example, terminals provided as outputs can be used as inputs and vice versa. From the point of view of current electronics, this can result in “dumb” overall circuits, which obtain their “intelligence” through training. Hardware-based artificial neural networks can therefore also be referred to as trainable electronic networks. The circuit elements can also form the nodes of the corresponding network. The hardware-based artificial neural network can also be referred to as a physical neural network.

Unlike a software-based artificial neural network, where the output of each node in a layer of the network is determined sequentially, the output of the nodes of a hardware-based artificial neural network is obtained simultaneously for all nodes in a layer. This means that in software-based artificial neural networks, the number of nodes affects the time required to calculate the output of the artificial neural network. In hardware-based artificial neural networks, however, the number of nodes in a layer does not make any difference to the time it takes to determine the output. Only the number of layers determines the time taken to determine the output data.

The invention provides an apparatus for operating a hardware-based artificial neural network in which an interference signal is injected into at least one region of the hardware-based artificial neural network. The interference signal is injected into the entire region, i.e. the interference signal is present in the entire region, or the region corresponds to the regions of the hardware-based artificial neural network covered by the interference signal. The at least one region can be smaller than the overall hardware-based artificial neural network. Furthermore, the apparatus has an interference device, which can inject an interference signal into a hardware-based artificial neural network. To inject the interference signal, a coupling device is provided between the interference device and the hardware-based artificial neural network. In one example, the coupling device may comprise simply an air-filled space between the interference device and the hardware-based artificial neural network. The interference signal emitted by the interference device is passed through the coupling device to the at least one region and injected there. Injecting the interference signal causes an increase in the noise in the at least one region, so that the signal-to-noise ratio is reduced during the transmission of signals between the elements, e. g. nodes, of the hardware-based artificial neural network. Contrary to all efforts made in the implementation of electronic circuits, instead of an increase in the signal-to-noise ratio in the at least one region of the hardware-based artificial neural network, a spatial and/or temporal and/or partial reduction of the signal-to-noise ratio is thus counterintuitively carried out. This reduction is limited to at least one region in which the interference signal is injected, i.e. it is limited to some electronic components of the hardware-based artificial neural network circuitry. The signal-to-noise ratio (S/N) is defined by: S/N=10*log (useful power/noise), expressed in decibels (dB), or S/N=20*log (useful signal voltage/noise signal voltage). Readily transmissible signals have an S/N of greater than 15 dB, and an S/N of less than 10 dB is considered to be highly noisy. If the useful signal power is equal to the noise signal power, the signal is no longer identifiable at the receiver. The performance of the hardware-based artificial neural network trained with injected interference signals is surprisingly improved. Since the training is carried out using the injected interference signals, the normal operation of the hardware-based artificial neural network is also carried out with the injection of the interference signals. Increasing the performance is understood to mean, inter alia, that the recognition of patterns, e.g. images or speech, is performed correctly with an increased probability, without the number of nodes in the network being increased. An improved hardware-based artificial neural network in which the abovementioned disadvantages of the prior art are eliminated is thus provided.

According to one example, the hardware-based artificial neural network in the at least one region can have at least one component, which is designed to reduce the signal-to-noise ratio upon receipt of the at least one interference signal, wherein the interference device preferably generates an optical, acoustic, capacitive, electromagnetic, quantum-mechanical, resistive, thermal and/or ionizing interference signal.

The signal-to-noise ratio is reduced by increasing the noise in the component. For this purpose, the component may be designed to be sensitive to the interference signal. For example, if an optical interference signal is used, the noise in the component during transmission of electrical signals in the component can be increased.

According to a further example, the interference device can have a plurality of individually actuatable interference elements for injecting an interference signal into the hardware-based neural network, wherein the interference elements preferably inject an interference signal into different regions of the hardware-based artificial neural network.

Thus, multiple regions of the hardware-based artificial neural network, preferably the entire hardware-based artificial neural network, can be influenced by interference signals. Since the interference elements can be controlled independently of each other, each region in the hardware-based artificial neural network can be individually subjected to its own interference signal.

The regions may overlap and/or be separate from each other.

Furthermore, the plurality of the interference elements can be arranged to be distributed over a layer, for example, preferably in the form of an array, wherein the coupling device comprises a medium having a plurality of coupling elements for transmitting the at least one interference signal into the at least one region, the coupling elements being distributed in the layer like the interference elements.

Thus, the interference elements can be used to generate an interference signal pattern, which is accordingly transmitted via the coupling device with the coupling elements to the hardware-based artificial neural network. Since the distribution of the interference elements in the layer is known, specific regions in the hardware-based artificial neural network can be targeted with interference signals. In particular, the distribution of the interference elements in the layer may be designed in such a way that the interference elements are arranged analogously to the components of the neural network. This allows specific interference signals to be injected into individual components.

Further, at least some of the plurality of interference elements may be designed as a resistance heater, a Peltier element, light-emitting diode, electromagnetic radiator and/or transmitter, and/or a piezo-component.

In a further example, the at least one region can have an extent which corresponds to the size of the hardware-based artificial neural network or is designed to be smaller than the size of the hardware-based artificial neural network.

If the at least one region has the same extent as the hardware-based artificial neural network, the interference device or the coupling device can be formed homogeneously in order to apply an interference signal homogeneously to the entire hardware-based artificial neural network. A finer degree of structuring allows the interference signals to be injected into different regions in a component, for example, only to a signal input or a signal output of a circuit element of the hardware-based artificial neural network. For example, if the extent of the at least one region is equal to the extent of a component of the hardware-based artificial neural network and each component is assigned one region, an independent interference signal can be injected into each component of the neural network.

The plurality of coupling elements can thus have a structure that is the same as the structure of the plurality of interference elements. Furthermore, the structure of the coupling elements can also correspond to the structure of the hardware-based artificial neural network. However, this does not exclude the possibility that the structuring of the coupling elements might be finer or coarser than that of the interference elements or of the hardware-based artificial neural network.

According to another example, the apparatus may comprise at least one semiconductor chip, wherein the semiconductor chip comprises the hardware-based artificial neural network, the hardware-based artificial neural network being preferably formed in an integrated circuit, more preferably in a field programmable gate array (FPGA) or in an application-specific integrated circuit (ASIC).

The neural network may be designed as a circuit on the semiconductor chip, wherein the nodes of the neural network can be formed as components of the circuit. In the example in which the elements of the neural network are designed as components of a Field Programmable Gate Array, the Field Programmable Gate Array may be configured such that the circuit structure of the elements of the Field Programmable Gate Array forms a neural network. A hardware-based artificial neural network which is also implemented in a Field Programmable Gate Array can be trained further. In contrast, a hardware-based artificial neural network is hard-wired on an application-specific integrated circuit and must be optimized in other ways beforehand.

It is also conceivable that the apparatus can comprise a shielding device for shielding external interference signals which are of the same type as the at least one interference signal, wherein the shielding device surrounds the hardware-based artificial neural network, the coupling device and the interference device.

The shielding device may be designed, for example, as an enclosure which forms an outer shell of the apparatus.

The interference device, the coupling device and the hardware-based artificial neural network are therefore surrounded by the shielding device. The shielding device can shield external interference signals, which may change the signal-to-noise ratio in an uncontrolled and non-reproducible manner. Thus, the interference signals of the interference device will almost exclusively cause the change in the signal-to-noise ratio in the regions of the neural network.

In a second aspect, the invention relates to an arrangement of a plurality of apparatuses according to the preceding description, wherein the hardware-based artificial neural networks of each apparatus are electrically connected to one another in series and/or parallel, wherein the interference devices of at least a first apparatus of the plurality of apparatuses and of a second apparatus of the plurality of apparatuses are preferably designed as a common interference device, an output layer of the hardware-based artificial neural network of a third apparatus of the plurality of apparatuses being preferably also designed to control the interference device of a fourth apparatus of the plurality of apparatuses.

Advantages and effects as well as refinements of the arrangement arise from the advantages and effects as well as refinements of the above-described apparatus. In this respect, for the avoidance of repetition, reference is therefore made to the preceding description.

The arrangement comprises at least two apparatuses according to the preceding description. In the arrangement, the output layer of a hardware-based artificial neural network of a first apparatus is electrically connected, inter alia, to an input of an interference device of a second apparatus or plurality of other apparatuses. The first apparatus can then control the interference device of the second apparatus or influence its function. In this way, each apparatus can be coupled to the interference devices of other apparatuses of the arrangement via an electrical connection of their neural networks.

Furthermore, in a third aspect, the invention relates to a system comprising a plurality of arrangements according to the preceding description, wherein a first arrangement of the plurality of arrangements is designed to control at least one interference device in a second arrangement of the plurality of arrangements.

Advantages and effects as well as refinements of the system arise from the advantages and effects as well as the refinements of the above-described apparatus and the arrangement. In this respect, for the avoidance of repetition, reference is therefore made to the preceding description.

The first arrangement may form, for example, a base layer, the apparatuses of which emit an output signal which is processed by the apparatuses of the second arrangement, for example after further processing, as an input signal. In this case, at least one interference device of an apparatus of the second arrangement may be coupled to the output layer of at least one apparatus of the first arrangement. This can be referred to as forward coupling. It is further conceivable that at least one interference device of an apparatus of the first arrangement can be coupled to the output layer of at least one apparatus of the second arrangement. This can be referred to as backward coupling.

Furthermore, multiple systems can be regarded as sub-systems and be combined in a complex system, wherein the sub-systems are coupled to each other in the manner described above. In this way, a more complex system with further increased performance can be formed. A complex system such as this, for example, can (optically and acoustically) process signals of various kinds, with one sub-system processing the optical signals and another sub-system processing the acoustic signals.

In a fourth aspect, the invention relates to a method for training an artificial neural network in an apparatus according to the preceding description, the method comprising at least the following steps: defining target output data during the processing of supplied training data; feeding the training data into the hardware-based artificial neural network and injecting at least one interference signal into the at least one region of the hardware-based artificial neural network by means of the at least one interference device; obtaining output data from the hardware-based artificial neural network; determining whether at least one deviation exists between the output data and the target output data, said deviation being located outside a predetermined tolerance range; if the deviation is within the tolerance range: terminating the method; and if the deviation is located outside the predetermined tolerance range: modifying the hardware-based artificial neural network and preferably modifying the at least one interference signal and repeating the above steps.

Advantages and effects as well as refinements of the method arise from the advantages and effects as well as refinements of the above-described apparatus. In this respect, for the avoidance of repetition, reference is therefore made to the preceding description.

The method is used to train a hardware-based artificial neural network in a state that is perturbed by the interference device. The training of the neural network thus takes place with an interference of the signal transmission in the at least one region in which an interference signal is injected. In addition to the changes made to the hardware-based artificial neural network, changes to the at least one injected interference signal are also made during each training run. For this purpose, at least one parameter of the at least one interference signal, e.g. an intensity, a frequency, a duration, etc., can be changed. Changing the at least one parameter will also change the at least one interference signal. With the method, an interference device can thus be integrated into the training of a neural network. Thus, using the method a trained hardware-based artificial neural network can be provided, which has an increased performance over a neural network into which no interference signals are injected.

According to one example, a signal-to-noise ratio of not greater than 15 dB, preferably not greater than 10 dB, further preferably not greater than 0 dB, can be generated in the at least one region by means of the injected interference signal.

Generally, it is the case that readily transmissible signals have a signal-to-noise ratio of more than 15 dB. A signal-to-noise ratio of less than 10 dB is considered to be highly noisy. If the useful signal power is equal to the noise signal power, the signal is no longer identifiable at the receiver. Nevertheless, a neural network can in principle also detect patterns in the noise at a signal-to-noise ratio of 0 dB or less, so that even with a signal that is no longer identifiable the output of the subsequent nodes of the neural network can still be influenced. The signal-to-noise ratio may also be less than 0 dB, preferably a minimum of −40 dB, more preferably −15 dB, further preferably −10 dB.

It is also conceivable that before the step of: defining target output data during the processing of supplied training data, the hardware-based artificial neural network can be trained, for example, without injecting interference signals.

This means that the neural network can be trained first, as is known from the prior art, in order to obtain an initial performance, e.g. a first accuracy value for the recognition of certain patterns. By means of the subsequent additional training with the injection of interference signals, the initial performance can be exceeded, wherein, for example, a second accuracy value for the detection of the specific patterns is achieved which is greater than the first accuracy value.

According to a further example, the at least one interference device can have at least a plurality of individually actuatable interference elements, wherein each interference element is designed to inject an interference signal into the hardware-based neural network, wherein each interference element preferably injects an interference signal into a different region of the hardware-based artificial neural network, and the plurality of the actuatable interference elements can be actuated in such a way that the interference signals form a predefined interference signal pattern over the hardware-based artificial neural network, wherein a plurality of training iterations of the hardware-based artificial neural network are preferably carried out sequentially with different predefined interference signal patterns.

The predefined interference signal patterns can be used, for example, for an initial training iteration. In subsequent training runs, the interference signal pattern can be changed by changing the activity of individual or more than one of the individually actuatable interference elements, e.g. by reducing or increasing the signal strength. Because a predefined interference signal pattern can initially be injected, the training can be accelerated by using interference signal patterns already classified as suitable. Furthermore, the predefined interference signal pattern can also be used unchanged throughout the entire training.

According to a fifth aspect, the invention relates to a method for training artificial neural networks in an arrangement according to the preceding description, wherein the method for training an artificial neural network in an apparatus according to the preceding description is applied to the hardware-based artificial neural networks of the apparatuses, preferably after the apparatuses have been separately trained outside the arrangement by means of the method for training an artificial neural network in an apparatus according to the preceding description.

Advantages and effects as well as refinements of the method for training artificial neural networks in an arrangement result from the advantages and effects as well as refinements of the apparatus described above, the arrangement, and the additional previously described method. In this respect, for the avoidance of repetition, reference is therefore made to the preceding description. Using the method for training artificial neural networks in an arrangement, all apparatuses of the arrangement can be matched to one another by the training to improve the performance of the arrangement. For this purpose, the apparatuses of the arrangement can be trained together right from the outset. Alternatively, the apparatuses can each be trained in isolation first, wherein no corresponding interference signal device is influenced by the output signals of another device. Only in a second training run, in which the apparatuses of the arrangement are matched to one another, can the interference devices be influenced by the output signals of other apparatuses of the arrangement.

In a sixth aspect, the invention relates to a method for training artificial neural networks in a system according to the preceding description, wherein the method for training an artificial neural network in an apparatus according to the preceding description is applied to the hardware-based artificial neural networks of the apparatuses, preferably after the arrangements have been trained separately outside the system by means of the method for training artificial neural networks in an arrangement according to the preceding description.

Advantages and effects as well as refinements of the method for training artificial neural networks in a system result from the advantages and effects as well as refinements of the apparatus, the arrangement, the system and the other previously described methods described above. In this respect, for the avoidance of repetition, reference is therefore made to the preceding description. In the method for training artificial neural networks in a system, the different arrangements of the system are coordinated with each other. In this case, the arrangements can initially be trained individually without the apparatuses of other arrangements affecting the interference signal devices. Further, in this case, before training the arrangements, the devices of the arrangements can be trained separately from each other without any influence on the interference devices by other apparatuses. Alternatively, the arrangements and the apparatuses contained in them can be matched to one another in a single training of the system, wherein output signals of the arrangements can affect the interference devices of other arrangements.

In the following, the invention is described using an exemplary embodiment by reference to the accompanying drawing, in which:

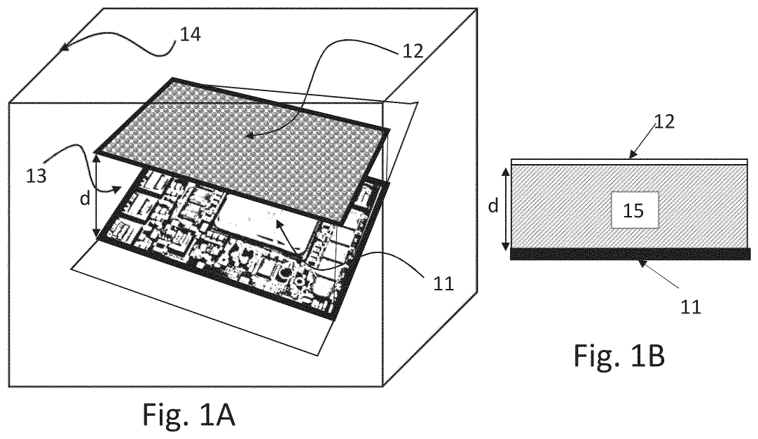

FIGS. 1A, B show a schematic illustration of the apparatus;

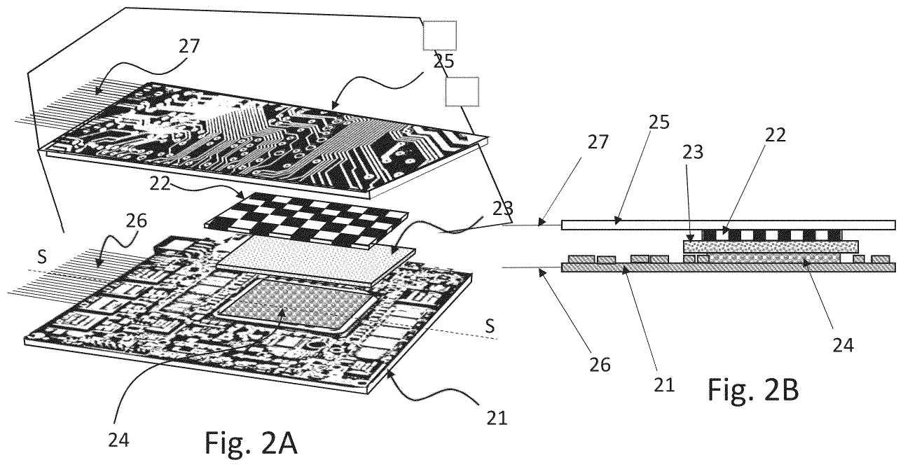

FIGS. 2A, B show a schematic representation of the apparatus according to FIG. 1A, b with further details;

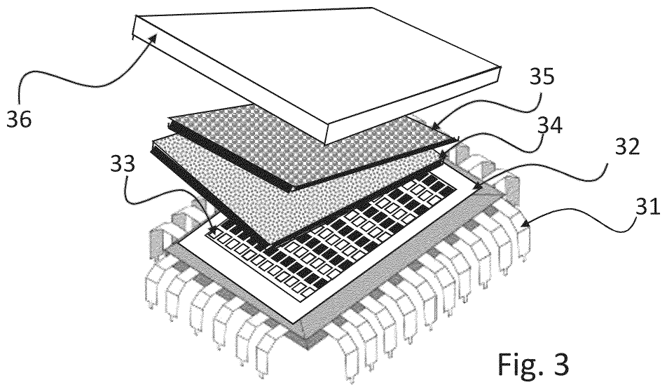

FIG. 3 shows a schematic representation of an example of the apparatus with an FPGA chip;

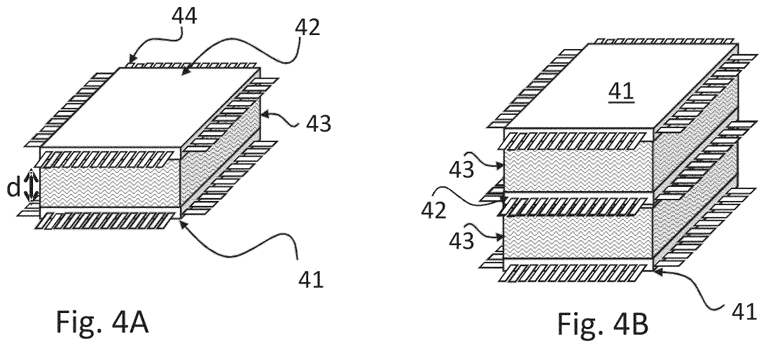

FIGS. 4A, B show a schematic representation of the example from FIG. 3 in further embodiments;

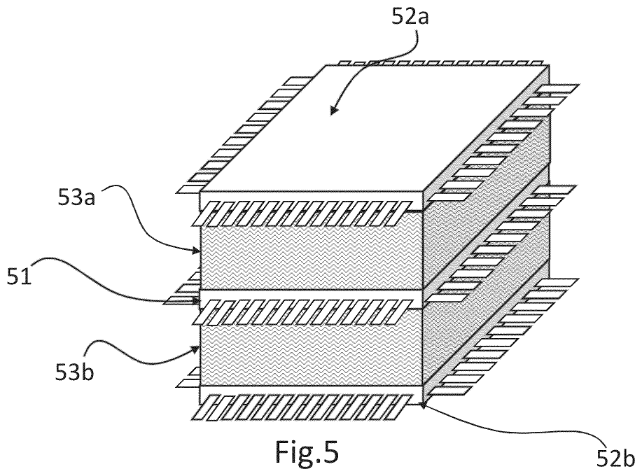

FIG. 5 shows a schematic representation of an example of the apparatus with two interference devices;

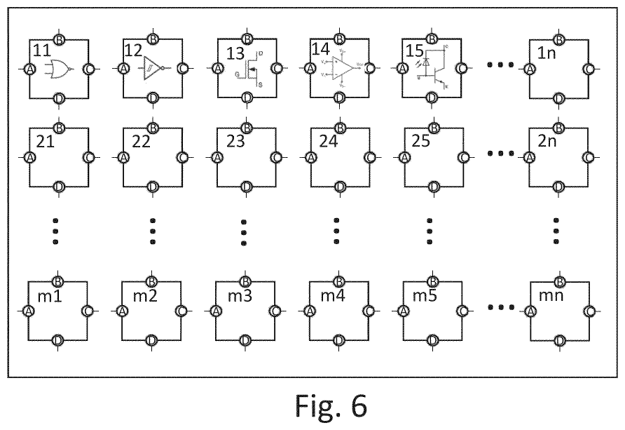

FIG. 6 shows a schematic representation of a basic structure of an FPGA chip;

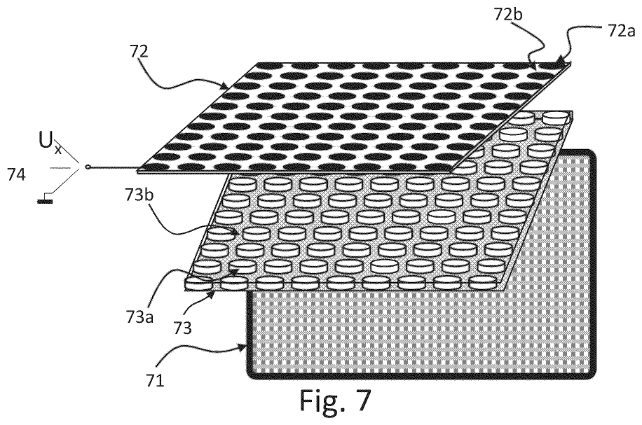

FIG. 7 shows a schematic representation of an example of the apparatus with capacitive interference elements;

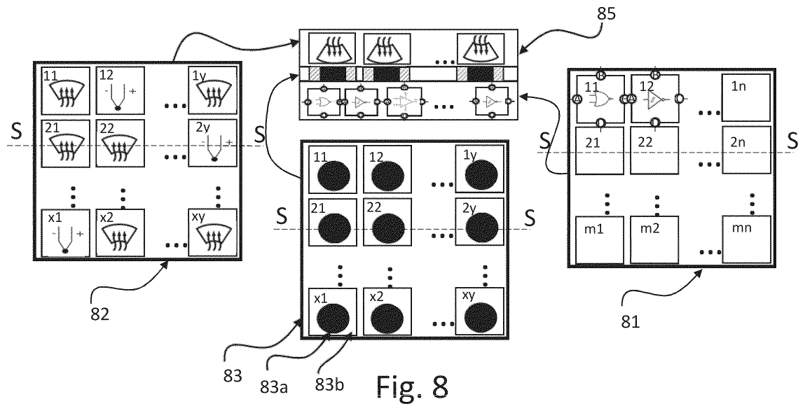

FIG. 8 shows a schematic representation of an example of the apparatus with heating and cooling interference elements;

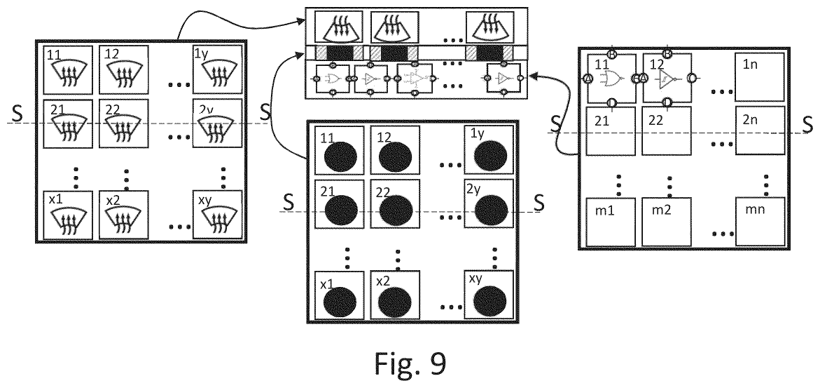

FIG. 9 shows a schematic representation of an example of the apparatus with heating interference elements;

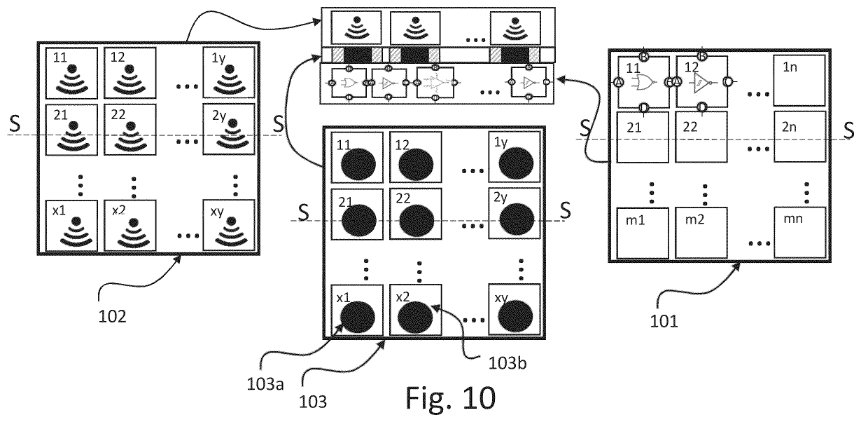

FIG. 10 shows a schematic representation of an example of the apparatus with sound-emitting interference elements;

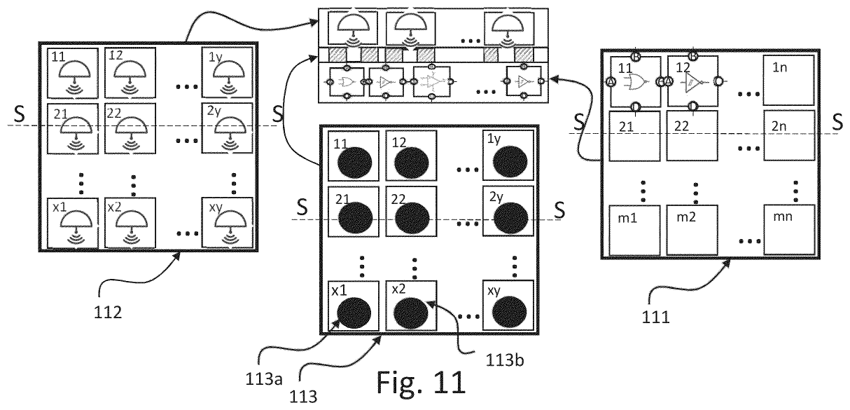

FIG. 11 shows a schematic representation of an example of the apparatus with interference elements that emit electromagnetic radiation;

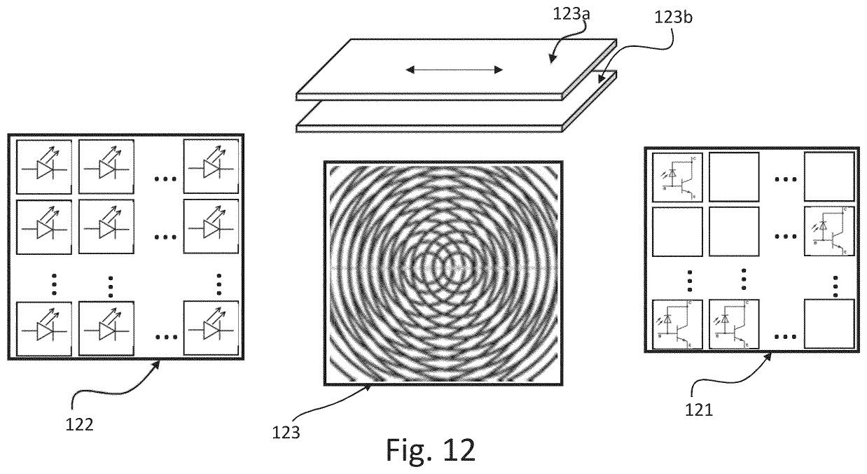

FIG. 12 shows a schematic representation of an example of the apparatus with a pattern-generating interference signal device;

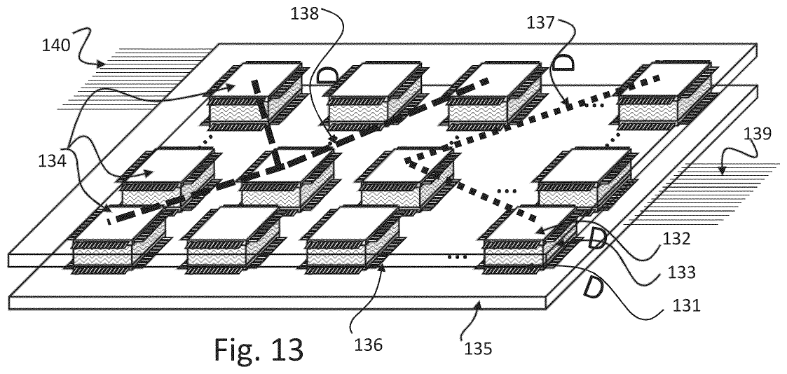

FIG. 13 shows a schematic representation of an arrangement with a plurality of apparatuses;

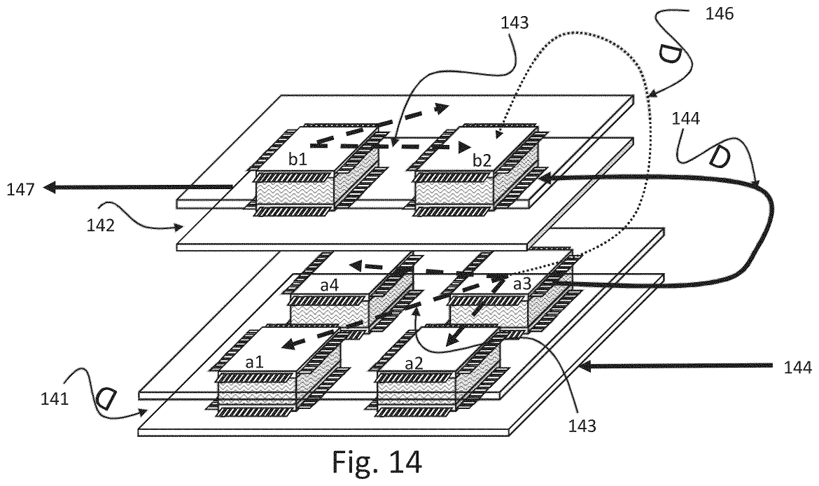

FIG. 14 shows a schematic representation of a system having a plurality of arrangements;

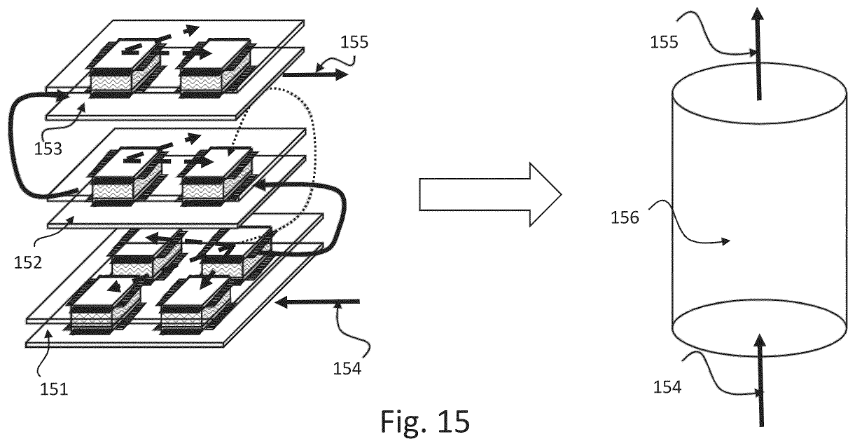

FIG. 15 shows a schematic representation of a further example of the system in an alternative mode of representation;

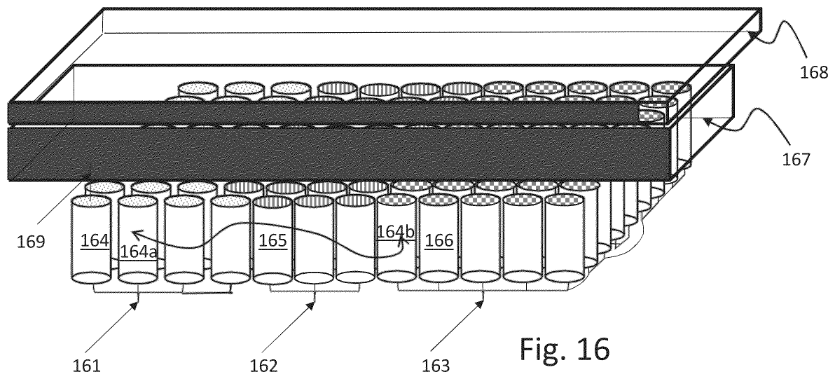

FIG. 16 shows a schematic representation of an example having a plurality of systems networked to each other via the interference devices;

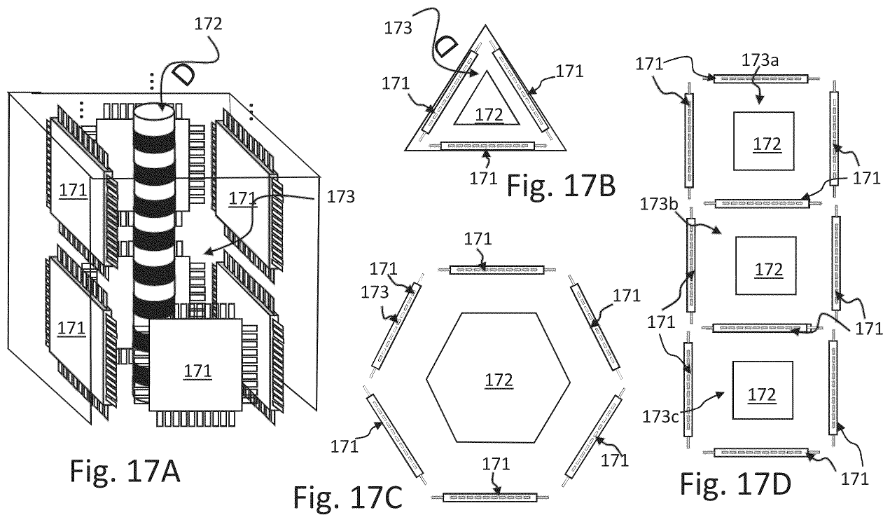

FIG. 17 shows a schematic representation of further examples of an arrangement of apparatuses;

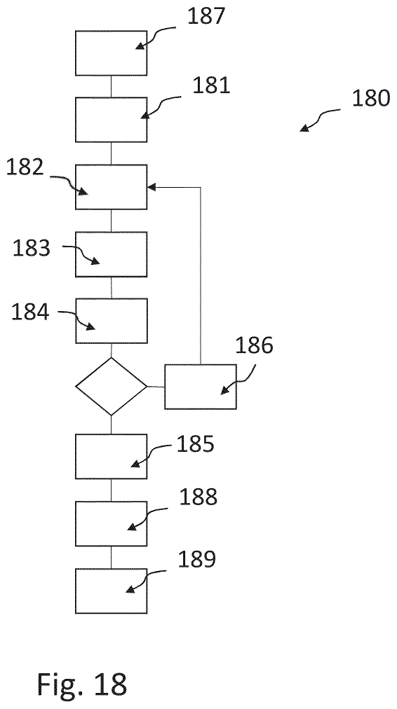

FIG. 18 shows a flowchart of the method for training artificial neural networks in a system.

FIGS. 1A and 1B show the apparatuses, which are further expanded upon below: according to FIG. 1A in a spatial arrangement, according to FIG. 1B the essential components of the apparatus in a sectional view. This example shows an FPGA chip on a control circuit board 13, the individual components of which are linked via an evolutionary learning process, configured and trained to form a hardware-based artificial neural network 11. This layer of the hardware-based artificial neural network 11 largely corresponds to the industrially available chip-based systems and activation mechanisms described in the prior art.

The term “FPGA” is used in the following to represent all freely configurable electronic semiconductor chips. At a distance d, which is specified in more detail in the following examples, a further layer with an optionally array-like structure is arranged as an interference device 12, the elements of which, shown here as small spheres, can be switched on/off or adjusted in a controlled manner as interference elements. The actuation elements are not shown here.

This layer of the interference device 12 can generate interference signals in patterns and is referred to as the “interference signal layer”. They or their elements can generate interference signals which, via the space which is part of a coupling device 15, are cross-coupled into the layer of the hardware-based artificial neural network 11 locally into at least one region of the hardware-based artificial neural network 11, the interference signal being injected into the entire region. The region therefore corresponds to the regions of the hardware-based artificial neural network 11 covered by the interference signal. The region can cover the entire network, meaning that the interference signal can be injected into the entire network. This can be carried out homogeneously. Furthermore, if, for example, multiple regions are provided, the extent of the regions can be assigned to a group of individual components of the FPGA, separate individual components or only to sub-regions of the individual components.

Suitable interference signal array components can be miniaturized heating or cooling elements, optical, acoustic, resistive, electromagnetic, capacitive, mechanical or even quantum-mechanical components.

Anything that can be injected into an electronic circuit, as realized in the layer of the hardware-based artificial neural network 11, is applicable.

Via the coupling device 15, which is hereinafter also referred to as the “coupling space”, the signals generated in the interference device 12 can be cross-coupled into the layer of the hardware-based artificial neural network 11 as patterns. Corresponding to the elements of the layer of the interference device 12, the coupling device 15 can be a medium, which, for example, mediates a thermal, resistive, electromagnetic, capacitive, mechanical or even quantum-mechanical transmission of the signals. In the simplest case, it can be a homogeneous medium, e. g. gas, liquid or solid. As a rule, however, the medium may comprise a vertically and/or horizontally structured combination of different materials to achieve a local effect in the direction of the layer of the hardware-based artificial neural network 11 and adapted to their array structuring, meaning that the medium of the coupling device 15 can be adapted to suit the arrangement of the linkable elements of the FPGA chip, i.e. to the hardware-based artificial neural network. The distance d can also be varied, but will usually be chosen to be small in comparison to the surface area of the layer of the hardware-based artificial neural network 11, in order to be able to generate local effects in the hardware-based artificial neural network 11, in particular in the FPGA chip.

In contrast to conventional uses of semiconductor chips and semiconductor components, the components on board the layer of the hardware-based artificial neural network 11 may be partially and not completely shielded from external effects, so that injections are only possible from the layer of the interference device 12.

Therefore, due to the increased sensitivity of the components of the hardware-based artificial neural network 11 to external signals, an encapsulation of the apparatus can be provided as a shielding device 14 against precisely these interference signals.

In this basic arrangement of a hardware-based artificial neural network 11 according to the invention, the main component for the evolutionary learning process is the layer of the hardware-based artificial neural network 11. The layer of the interference device 12 forms a higher-level, but subordinate component, which makes this process in the layer of the hardware-based artificial neural network 11 more complex and can also be optimized via the or a second evolution algorithm and learning process. The overall unit from 11 to 15 can be understood and referred to as an intelligent hardware AI system and can be referred to as an AI basic unit.

The training process can be carried out in two variants. In a first alternative, the hardware-based artificial neural network 11 and the interference device 12 can be modified simultaneously in the evolutionary process. In a second alternative, only the hardware-based artificial neural network 11 might be trained first and, if this training shows positive results, the interference device 12 can be added. If the apparatus comprises more than one hardware-based artificial neural network 11 and more than one interference device 12, any combination may be subjected to separate and joint training according to the first or second alternative.

In contrast to prior art systems, by avoiding undefined interference effects, the defined separation of the interference signals by the interference device 12 and the coupling device, highly complex systems are realizable and controllable and the probability of achieving a positive training result increases.

FIGS. 2A and 2B illustrate an example which explains the spatial relationships. FIG. 2A shows a three-dimensional exploded drawing and FIG. 2B shows a section along the line S-S in FIG. 2A.

An FPGA chip 24, in which the hardware-based artificial neural network is implemented, may be arranged on a board 21, e.g. a multilayer PCB for actuating and configuring the FPGA via the terminals 26. Configuration can be carried out via digital computers. The FPGA 24 is not encapsulated in a shielded manner, but can instead be covered with the coupling medium 23 of the coupling device, followed by the interference device 22, which is shown here in the form of an array in a checkerboard pattern with individual interference elements for local generation of interference signals for the FPGA. The interference device 22 is in turn connected to a board 25 for actuating the interference elements via the terminals 27. In the simplest case, arbitrary patterns can be generated by switching the interference elements of the interference device on and off, which act locally on the FPGA chip 24 via the coupling medium 23.

With regard to the distance d from FIG. 1A, in this example it is small compared with the extent of the surface of the FPGA chip 24. Typically, the distance is between 0.1 mm and 5 mm, preferably 0.5 mm. The geometric relationships can be seen in the section S-S in FIG. 2B. As an example, the array of the interference device 22 may consist of small heating elements or Peltier elements, which can be structured via a medium 23 with high thermal conductivity, e.g. a metal or diamond layer. This layer can be structured as an array in columns with good and poor heat conduction to transfer a temperature pattern to the FPGA. This allows a variable, trainable and switchable interference signal pattern to be generated.

A first degree of structuring of the interference device, which is a measure of the structuring of the distribution of the interference elements, can be adapted to suit the structuring of the FPGA, the structuring of which can be specified in this example with a second degree of structuring, that is, selected to be geometrically similar. Then, in each region in which an interference signal is injected by the interference device into the hardware-based artificial neural network, implemented in the FPGA, a basic element of the FPGA is arranged. In other words, one basic element of the FPGA is then manipulated by each interference element.

However, this is not essential because the first degree of structuring can equally well be structured more finely as more coarsely than the second degree of structuring, with the ratio of the first degree of structuring to the second degree of structuring preferably having values in a range between 10:1 for the finer structuring and 0.1:1 for the coarser structuring.

The coupling medium 23 of the coupling device can have structuring, which is specified with a third degree of structuring. The third degree of structuring may also be finer or coarser than the second degree of structuring.

FIG. 3 shows a compact technical arrangement of the apparatus described in FIGS. 1A and 1B. In a semiconductor chip holder 31, e.g. a ceramic having a plurality of contact pads, an FPGA chip 32 with the linkable electronic basic components 33 may be arranged. In addition, the coupling medium 34 and the interference device 35 with an array of interference elements can be arranged directly thereon.

The entire chip can then be encapsulated 36 so as to be shielded against external influences. In the case of electromagnetic elements in the interference device, this can be e.g. a metal encapsulation, in the case of optical interference signals it can be a non-transparent coating. This compact chip design allows the combination of such chips on one board to form complex structures or even stacks, as explained in the following examples. Chips of this kind can be used to assemble a plurality of AI basic units and combine them into layers and hierarchies.

FIGS. 4A and 4B schematically illustrate the exemplary combination of compact chip systems. FIG. 4A shows an apparatus as an AI basic unit according to FIG. 3, comprising the FPGA 41, the coupling medium 43 of the coupling device and the interference device 42 with the electrical contact pads 44. The thickness of the coupling medium can vary between 100 μm and 5 mm, preferably from 200 μm to 600 μm. Furthermore, the coupling medium may have a plurality of coupling elements, which can be structured or unstructured according to a third degree of structuring. In particular for using signal patterns, a structuring of the coupling medium is provided.

In FIG. 4B, two apparatuses are shown combined with each other. The combination of the two apparatuses has two FPGAS 41, which are connected to a common interference device 42 via two coupling media 43. The FPGAS are aligned head-to-head.

In an analogous manner, further combinations can be realized as horizontal or vertical stacks. The advantage of a common interference device for multiple FPGAs is the reduction of the actuation complexity.

Furthermore, interference signal patterns can be generated which are either fixed in advance or have been optimized by evolution-based methods during training with the FPGA. Such systems also offer the advantage that the upper and lower FPGA can also be subjected to different interference signal patterns in a temporally separated sequence or alternately, resulting in more complex training and more complex AI systems with low switching complexity.

FIG. 5 shows a further variant. In this example, an FPGA 51 is arranged between two coupling media 53a and 53b and two interference signal layers 52a and 52b. This results in multiple options for the injection of interference signals, in the context of growing but well-defined complexity of the apparatus.

For example, a symmetrical injection of identical interference signal patterns onto the center of the FPGA chip from above and below can be provided. Alternatively, for example, an asymmetrical injection of identical or different interference signal patterns into the FPGA chip can be provided. In another alternative, for example, a temporally separated injection from above and from below can take place. Furthermore, an alternating injection of asymmetrical interference signals from above and below can be provided, for example.

FIG. 6 schematically shows the basic principle and basic structure of FPGA chip arrays. Since the FPGAs are usually structured as an array, for reasons of intelligibility, the representation with rows 1 to m and columns 1 to n was chosen.

Via four connections A, B, C, D in each case, electronic basic elements, the position of which can be identified with the indices 11, 12, [. . . ] , m5, mn, can be connected to each other in a short-circuit-proof configuration to form a hardware-based artificial neural network. Even incorrect wiring connections, e.g. using the output of an element as an input, are also permitted in hardware-based artificial neural networks.

As shown by way of example with the basic elements at positions 11 to 15 in the top row of the array shown, the elements of the FPGA can be digital as well as analog circuits. The symbols used correspond to the electronic nomenclature. It is also possible to mix analog and digital devices. The electronic elements mn are not shielded against interference in the usual way, but may even have assemblies that react sensitively to optical, acoustic, thermal, electromagnetic and other signals generated by the interference device. The type of configuration and the evolutionary programs used for training are prior art and are therefore not explained in more detail here.

In FIG. 7, the three layers of the apparatus (hardware-based artificial neural network, coupling device and interference device) are shown with a capacitive interference.

The FPGA 71 in this example, as a hardware-based artificial neural network, has a second degree of structuring which is finer than the first and third degrees of structuring of the interference signal device 72 and the coupling device 73. The structuring of the FPGA, the interference device and the coupling device can be of the same or different type. Accordingly, it is then possible to not only manipulate a single basic element of the FPGA, but a group of basic elements simultaneously or only a sub-region of a basic element.

The interference device 72 may comprise, for example, small metal plates or metal pads 72a as interference elements, which are embedded in an electrically insulating medium 72b. Each pad 72a can be activated via a computer program in the same way as the operation of the FPGA. In the simplest example, three assignments of each pad are possible, as shown at 74: 1. Application of a positive or negative voltage Ux, 2. Open pad, i.e. no potential binding, wherein the pad searches for its potential in the chip environment itself, and 3. Connection to ground, so that arbitrary charge patterns can be generated in the array.

In the example shown, the coupling device 73 is structured in the same manner, so that under each metal pad a material having a high dielectric constant 73a, embedded in a medium having a low dielectric constant 73b, can be arranged as a coupling element. With the surface of the FPGA 71, the metal pads form local capacitors, via which displacement currents can be injected into each of the locally adjacent regions of the hardware-based artificial neural network.

In the evolutionary training process, the assignments of the interference elements 72a can be varied via an evolution algorithm, in a similar way to the training of the hardware-based artificial neural network. This means that at the outset a random assignment of input signals can be generated and applied for the interference device 72. The artificial neural network implemented in the FPGA can then receive an input signal. If this is interpreted correctly by the neural network at the output, nothing is changed in the configuration of the interference device 72 and the next training signal is applied to the FPGA.

If the input signal is evaluated incorrectly, for example, the assignment of a few pads or interference elements is changed on a random basis, as is also the case with the switching connections in the FPGA. Both algorithms can, but do not have to, match. If this is repeated a few hundred to a few thousand times, which can be referred to as “generations” in the evolutionary algorithm, the desired success rate of the entire apparatus can be achieved.

FIG. 8 shows a 3-layer AI chip in which interference signals can be generated via an array of heating and/or Peltier elements 82, which in this example represent the interference elements. The temperature can be transferred from the interference elements to the local basic elements of the FPGA 81 via the coupling device 83. The basic elements arranged as an array at positions 11 to mn of the FPGA can either be produced as temperature-sensitive elements according to the standard semiconductor manufacturing methods, or are designed in such a way that they react in terms of signal behavior to small temperature differences, for example, a few degrees or fractions thereof.

The coupling device 83 in this example is also composed of two components: the highly thermally conductive, cylindrical regions 83a and the poorly thermally conductive regions 83b in between. The material 83a can be, for example, a metal such as copper or silver, or a diamond layer processed by semiconductor technology. The insulation material 83b can be a poorly thermally conductive plastic material, glass or even a ceramic material.

The interference device 82 in this example can have a plurality of heating and/or cooling elements, e.g. miniaturized resistance elements or Peltier elements, as interference elements. In this way, arbitrary temperature patterns can be transferred to the FPGA underneath. The temperature differences can be selected in wide ranges, e.g. in a range between −20° C. and 100° C., but preferably in the degree range near to room temperature or below.

In the box 85, which is shown at the top center of FIG. 8, the structure of this AI basic unit is shown in the vertical section S-S. Here again, the array structure of the layers of the interference device, the coupling device and the neural network does not have to match, i.e. the number of interference elements and coupling elements can, but does not have to, correspond to the number of basic electronic elements.

The generated temperature patterns are typically static, meaning that they are constant for the working cycle of the neural network, which corresponds to a decision run. However, it is also possible to generate dynamic changes across multiple decision runs of the FPGA.

The training procedure is similar to the description in FIG. 7.

In FIG. 9, an apparatus is shown with an interference device which only has heating elements. Otherwise, this example is structured as described in FIGS. 7 and 8.

In FIG. 10, an interference device 102 is shown, which has miniaturized sound transmitters as interference elements, which emit sound signals of different frequencies, for example via vibration. The sound transmitters can be piezo-elements or piezo-crystals or small diaphragms which generate individually activated sound patterns.

In this example, the coupling device 103 can comprise sound-transmitting regions 103a, e.g. a mechanical solid-state coupling or miniature sonotrodes, and sound-damping intermediate spaces 103b, e.g. sound-absorbing materials, e.g. material with extremely small cavities.

The basic elements of the FPGA 101 can be designed in such a way that they can be perturbed to a certain extent via sound frequencies. The effect can be reinforced and designed to be more complex if the basic electronic elements of the FPGA have sound receiver components, for example. This can be the case for part or all of the basic elements of the FPGA. The advantage of the application of sound is its broad frequency range, which ranges from infrasound via the human hearing range to ultrasound. This allows not only sound patterns of one frequency, but also sound patterns of different frequencies to be generated.

This example graphically illustrates the extended range of possibilities associated with the introduction of interference devices and coupling devices into hardware-based artificial neural networks. In interconnected arrangements and systems, as explained in the following figures, each of these interference devices can be varied in intensity as a fixed sound pattern, shifted in frequency as a whole, modified in its frequency composition/spectrum, changed as a pattern, or operated in combinations of the above options.

If it is assumed that the entire system of hardware-based artificial neural network, interference device and coupling device has been optimized for a certain frequency pattern and achieves its highest success rate in this actuation pattern, a modification/detuning of the interference signals would lead to a worse result. In extreme cases, the neural network only functions in a certain intensity interval or frequency interval. This means that it is possible to use the interference signals alone to worsen or improve an apparatus if it has previously been operated in a suboptimal manner. This leads to the option of interconnecting many apparatuses in a hierarchical or even non-hierarchical manner in such a way that, via the success rate of a neural network, other hardware-based artificial neural networks connected to it can be influenced by their interference signals.

FIG. 11 shows an FPGA 111 comprising an artificial neural network of the type already described. In this example, the interference device 112 can have as interference elements miniaturized transmitters for high-frequency electromagnetic waves up to the microwave range, which can be designed, for example, in the manner of antennas or their signal can be transmitted to the FPGA via the coupling device 113 by means of a waveguide 113a as a coupling element.

Analogously, the interference device may have infrared or LED elements in the visible spectral range or in the UV range as interference elements. In addition, the injection can be carried out via optical fibers or small pinholes as coupling elements. A very wide range of possible operating and training types is also obtained for this apparatus, analogous to FIG. 10.

In FIG. 12, an alternative apparatus is shown with an interference device which can only generate interference signals in patterns. For this purpose, the coupling device 123 has two or more layers 123a, 123b, on which patterns may be applied, for example, on each layer concentric rings, which are alternately transparent and non-transparent, wherein the centers of the concentric rings of the two layers are shifted relative to each other. This results in symmetrical or asymmetrical superposition patterns. The interference device 122 can then have a light-emitting diode array. In this case, the coupling device 123 is not an array as in the preceding examples. Instead, the superposition pattern can define the pattern formed by the interference signals in the neural network. The FPGA chip 121 can have e.g. light-sensitive components in its electronic basic elements.

FIG. 13 shows an arrangement of devices as an ensemble of AI basic units corresponding to FIGS. 3 to 5. On the control circuit board 135, FPGA chips 131 can be electrically contacted, wherein the interference devices 132 can be electrically contacted on the underside of the upside-down, transparently illustrated control circuit board 136. The coupling devices 133 are arranged in between them.

Via first actuations 139 of the control circuit board 135 for the FPGAs 131 and second actuations 140 of the control circuit board 136 for the interference devices 132, the AI basic units 134 can be trained as already described, separately and/or jointly. If each AI basic unit 134 has been trained on a different group of features, for example, a first on the recognition of cats, a second on dogs, a third on horses, etc., then the arrangement in FIG. 13 forms a more complex AI system with higher performance/intelligence than the AI basic units exhibit as individual devices.

The interference devices can also be partially electrically connected to each other, as shown schematically via the interrupted lines 137, 138. This results in a further option for the control and the evolutionary training of the entire arrangement.

These connections can be used to transmit signals between the interference devices 132, which change the performance of other AI basic units in a fixed manner, for example exclusively via the respective injection of interference signals with which the corresponding artificial neural networks in the FPGAs can be manipulated as already explained above. This can be carried out, for example, by increasing or reducing the intensity of the interference signal in the connected AI basic unit. This means that each AI basic unit can act in an improved or even optimal manner, e.g. the devices connected via the dashed connecting line 138, or else be detuned and thus degraded or switched off, e.g. the devices connected via the connecting line 137. For example, in the animal recognition example above if it is assumed that half of the AI basic units can recognize animals, and the other half art objects that look like animals, then such an interconnection can ensure that initially many of the AI basic units are controlled in the suboptimal range by the detuning of the respective interference devices and are driven e.g. at 80% of the maximum performance. When the devices are provided with an input signal, e.g. the image of a mule, the individual AI basic units classify this input signal with different results.

The devices that can recognize cats will output, for example, a 2% match of the mule with a cat, those that can recognize horses will output, for example, a 90% match, those that can recognize art objects may also respond e.g. in the detection range of a few percent up to 60% in the case of horse sculptures. The AI basic unit with the highest match rate, in this case the devices that can recognize horses, can then switch its interference device to optimal operation. Furthermore, previously detuned interference devices of the AI basic units connected to it can also be switched simultaneously to the optimal interference signal mode, e.g. one AI basic unit for detecting wild horses, one for detecting zebras and one for detecting hybrids of the horse family. At the same time, via connections to the devices that can recognize art objects it can suppress all except the one with the highest percentage of hits. This device with the highest percentage of hits for detecting art objects can activate further devices that can detect works of art via its connections, by an optimal adjustment of the interference devices.

Now, a new iteration of the mule image can be started until it is decided which object in the whole system the mule comes closest to and whether it is an animal or an object.

Such an arrangement has one training layer more than the AI basic units, namely that of the interconnection of the devices to one another, which can also be achieved via evolutionary optimization strategies.

With a plurality of, at least two, arrangements according to FIG. 13, hierarchically or otherwise organized complex systems can be constructed, as shown in FIG. 14. A base layer 141 is shown, comprising an arbitrary number of AI basic units, wherein for reasons of clarity FIG. 14 shows, for example, only four devices with the designation a1 to a4, which can be interconnected with one another for activation or suppression via electrical connections 143 between the associated interference devices. In this layer, the input signal 144 can be fed into all AI basic units a1 to a4, e.g. by connecting the inputs of the devices in parallel.

The AI basic unit with the highest recognition probability can be cross-coupled to the next higher layer 142. There, the input signal 144 can now also be applied to all AI basic units, wherein for reasons of clarity only two devices b1, b2 are shown in layer 142, which can also be partially or completely interconnected via electrical connections 143 between the interference devices. In this layer also, an AI basic unit with the highest recognition probability can be determined, which can then generate the output signal 147.

Typically, the number of AI basic units can be a maximum in the lowest layer and decrease toward higher layers.

This is not essential, however. Expanded decision categories or new links can also be created with each layer. For example, patterns can be compared in the higher-level layers after the object has been recognized, and acoustic signals can be added in the next layer to reveal contradictions that would otherwise lead to a miscategorization. For example, if an object recognized as a cat neighs like a horse. Such a system can have larger AI basic units in higher layers than in a lower layer.

On the left of FIG. 15 a system with a hierarchical AI structure is shown, consisting of three layers 151, 152 and 153 with the input 154 and the output 155 analogous to FIG. 14. Such complex AI interconnections are grouped together in the following, as shown on the right of FIG. 15, as a cylinder 156 with the input 154 and the output 155, in order to be able to represent more complex structures.

FIG. 16 schematically shows an even more complex structure. It consists of a plurality of systems according to FIG. 15, which are shown as cylinders 164-166. They can be oriented in a layer in the same direction, wherein for reasons of clarity only the cylinder 164, by way of example, shows the respective input 161 oriented downwards and the respective output 169 oriented upwards.

The systems can be arranged in domains which are marked by a specific pattern on the top of the corresponding cylinders, with one pattern each marking the systems of a domain.

In FIG. 16, three domains are illustrated, which can be composed of three system types 164, 165, 166. As can be seen in system type 166, not all systems in a domain need to be directly adjacent. Individual systems can also be arranged in another domain as a solitary unit (not shown here). In this way, strong and weak interactions between the domains can be realized via the interference devices. The systems in a domain can receive a common input signal. It is expedient to organize the domains in such a way that they each receive different or modified input signals, e.g. parts of the general input signal, which in FIG. 16 are designated with the reference signs 161, 162 and 163.

There may be reciprocal or directed connections between the systems, via which they can be stimulated or suppressed, or can also stimulate or suppress other systems. These connections can usually start from the top layer, i.e. the result layer, see FIG. 15. When input signals 161 to 163 are applied, the individual systems can already arrive at more complex responses with different recognition probability than without these connections.

Analogous to the operation of the individual systems according to FIGS. 14 and 15, the systems within the domain and beyond it can be strengthened and weakened.

The connections to other domains, which can easily be very far apart, as illustrated for example by the connection arrow from system 164a to system 164b, allow larger system ensembles to be controlled in their activity via the interference devices. These ensembles of systems have a further training layer in addition to those already described above.

The system with the highest hit rate of a domain can be cross-coupled via a switching layer 167, which feeds the result into a projection layer 168 in which the results of the other domains with high hit rates and the input signal can be input and displayed for comparison.

This arrangement allows, for example, pandemonium-like structures to be implemented, such as are suspected to exist in the human brain. The systems correspond to the column structure of the cerebral cortex, the domains, for example, to the optical, acoustic, haptic, or olfactory cortex. Via the cross-connections between the systems and between the domains, association-like modes can be created and trained which ultimately represent nothing other than associations between phenomena that are not actually related to each other, for example, the implementation of an optical pattern in music, etc. As can be seen, with the underlying apparatuses, e.g. FGPAS with interference device, their interconnection and manipulation via the interference devices, the linking of apparatuses to form arrangements and their aggregation in systems, subsequently via the arrangement of the systems in layers and domains, an overall AI system can be created, which can be made universally intelligent via a plurality of evolutionary training cycles to be carried out sequentially and/or simultaneously. The more extensive the systems, the more complex the training structure can be made.

FIGS. 17A to 17D show alternative apparatuses. In the event that the interference devices 172 are not to be arranged close to the FPGAs 171 in order to inject interference signals in patterns not as fine as in FIGS. 1 to 16, but to inject them more widely and for many FPGAs in the same or similar manner, the apparatus may comprise a plurality of FPGAs 171 and control circuit boards which are arranged, for example, as per FIG. 17A, in a square around a common interference device 172, which can be configured as a column. Such a group of four FPGAs 171, or for example even a group of eight (for reasons of clarity only seven are shown), can then form an AI basic unit in conjunction with the interference device 172 and the intervening coupling device 173.

FIGS. 17B to 17D show further examples of apparatuses in plan view. In FIG. 17B, the FPGAs of an apparatus are arranged in a triangle arrangement and in FIG. 17C in a hexagonal arrangement.

FIG. 17D shows an apparatus of which the FPGAs and thus hardware-based artificial neural networks are arranged in a rectangle-chain system. The coupling medium of the coupling device 173 may be a gas or a material that readily transmits the respective interference signals to the FPGA chips. As a rule, it can be formed homogenously from the interference signal column 172 due to the breadth effect. Alternatively, it may comprise a layered or other type of composition of highly and poorly transmitting materials. Other groupings can be implemented in an analogous manner. Common to all of them is that they can be combined into more complex arrangements, systems and ensembles, as described in FIGS. 13 to 16.

FIG. 18 shows a flowchart that illustrates a method for training a system according to the preceding description, wherein firstly a method 180 for training an artificial neural network in an apparatus according to the preceding description is carried out. The apparatuses of the system can be initially trained.

In a first optional step 187 of the method 180, the hardware-based artificial neural network of an apparatus can initially be trained without the injection of interference signals. In this step, the hardware-based artificial neural network is trained to a preliminary performance value.

In a further step 181, target output data can be defined which represents the desired result of the processing of supplied training data by the hardware-based artificial neural network. This step can be performed at any time before the subsequent steps and also simultaneously or before the optional step 187.

Furthermore, in step 182, the supplied training data can be used for the training of the hardware-based artificial neural network. For this purpose, the training data is fed into the input layer of the neural network, wherein the interference device injects interference signals into at least one region of the hardware-based artificial neural network. In this process, parts of a node of the hardware-based artificial neural network, an entire node or multiple nodes may be arranged in the at least one region.

In a further step 183, the output data of the hardware-based artificial neural network is obtained. Because the network is hardware-based, the training data is processed simultaneously across all nodes of a network layer, so that the output data is available within a few ms.

Thereafter, in step 184 a deviation between the output data and the target output data is determined. If the deviation is outside a predefined tolerance range, for example, if the deviation is greater than 1%, the hardware-based artificial neural network is reconfigured. The at least one interference signal can also be optionally modified. If multiple interference signals are used, it is sufficient to modify a single interference signal, e.g. by activating an interference element of the interference device.

Steps 182 to 184 are repeated with the modified hardware-based artificial neural network and the possibly modified interference signals being fed in.

If the deviation is within the predefined tolerance range, the training of the apparatus is ended at step 185.

When all apparatuses have been trained with the method 180, an arrangement of the apparatuses can be trained in a further method 188. For this purpose, the apparatuses of the arrangement coupled to each other via the interference devices are trained in accordance with steps 182 to 186. However, this does not rule out the possibility of also training the arrangement without carrying out the method for the apparatuses beforehand.

In the training of the arrangement it is possible to proceed in a similar way to the method 180, wherein at least some interference devices can be influenced or controlled by the hardware-based artificial neural networks of other apparatuses.

When all the arrangements of a system have been trained using the method 188, the system can be trained according to the method 189. For this purpose, the apparatuses or arrangements of the system coupled to each other via the interference devices are trained in accordance with steps 182 to 186. However, this does not rule out the possibility of also training the system without carrying out the method for the arrangements or the apparatuses beforehand.

Furthermore, an ensemble can be trained in such a way that the systems are trained according to the description given above first and then the entire ensemble. However, this does not rule out the possibility of also training the ensemble without prior training of the systems, the arrangement and/or the apparatuses.

The example described above does not in any way limit the invention. Rather, the invention can be modified in a variety of ways. All the features of the invention described above may be essential to the invention, either alone or in combination with each other.

1. An apparatus for operating a hardware-based artificial neural network, comprising at least one hardware-based artificial neural network (11, 24, 32, 41, 51, 71, 81, 101, 111, 121, 131, 171) which links together modifiable electronic elements to form an artificial neural network, characterized in that the apparatus comprises at least one interference device (12, 22, 35, 42, 52a, 52b, 72, 82, 102, 112, 122, 132, 172) for injecting at least one interference signal into at least one region of the hardware-based artificial neural network and at least one coupling device (15, 23, 34, 43, 53a, 53b, 73, 83, 103, 113, 123, 133, 173), the coupling device being positioned between the interference device and the hardware-based artificial neural network and being designed to transmit the at least one interference signal from the interference device to the entirety of the at least one region.

2. The apparatus as claimed in the preceding claim, wherein the hardware-based artificial neural network in the at least one region has at least one component, which is designed to reduce the signal-to-noise ratio upon receipt of the at least one interference signal, wherein the interference device preferably generates an optical, acoustic, capacitive, electromagnetic, quantum-mechanical, resistive, thermal and/or ionizing interference signal.

3. The apparatus as claimed in any one of the preceding claims, wherein the interference device has a plurality of individually actuatable interference elements (72a) for injecting an interference signal into the hardware-based neural network, wherein the interference elements preferably inject an interference signal into different regions of the hardware-based artificial neural network.

4. The apparatus as claimed in claim 3, wherein the plurality of the interference elements are arranged to be distributed over a layer, preferably in the form of an array, wherein the coupling means comprises a medium having a plurality of coupling elements (73a, 83a, 103a, 113a) for transmitting the at least one interference signal into the at least one region, the coupling elements being distributed in the layer like the interference elements.

5. The apparatus as claimed in any one of claims 1 to 4, wherein the at least one region has an extent which corresponds to the size of the hardware-based artificial neural network or is designed to be smaller than the size of the hardware-based artificial neural network.

6. The apparatus as claimed in any one of the preceding claims, wherein the apparatus has at least one semiconductor chip, wherein the semiconductor chip comprises the hardware-based artificial neural network, wherein the hardware-based artificial neural network is preferably formed in an integrated circuit, more preferably in a field programmable gate array or in an application-specific integrated circuit.

7. The apparatus as claimed in any one of the preceding claims, wherein the apparatus comprises a shielding device (14, 36) for shielding external interference signals which are of the same type as the at least one interference signal, wherein the shielding device surrounds the hardware-based artificial neural network, the coupling device and the interference device.

8. An arrangement of a plurality of apparatuses as claimed in any one of the preceding claims, wherein the hardware-based artificial neural networks of the apparatuses are electrically connected to one another in series and/or in parallel, wherein preferably the interference devices of at least a first apparatus of the plurality of apparatuses and of a second apparatus of the plurality of apparatuses are designed as a common interference device, wherein more preferably an output layer of the hardware-based artificial neural network of a third apparatus of the plurality of apparatuses is designed to control the interference device of a fourth apparatus of the plurality of apparatuses.

9. A system comprising a plurality of arrangements as claimed in claim 8, wherein a first arrangement of the plurality of arrangements is designed to control at least one interference device in a second arrangement of the plurality of arrangements.

10. A method for training an artificial neural network in an apparatus as claimed in any one of claims 1 to 7, wherein the method (180) comprises at least the following steps:
defining (181) target output data during the processing of supplied training data;
feeding (182) the training data into the hardware-based artificial neural network and injecting at least one interference signal into the at least one region of the hardware-based artificial neural network by means of the at least one interference device;
obtaining (183) output data from the hardware-based artificial neural network;
determining (184) whether at least one deviation exists between the output data and the target output data, said deviation being located outside a predetermined tolerance range;
if the deviation is within the tolerance range:
terminating (185) the method; and
if the deviation is located outside the predetermined tolerance range:
modifying (186) the hardware-based artificial neural network and preferably modifying the at least one interference signal, and repeating the above steps 182 to 184.

11. The method as claimed in claim 10, wherein a signal-to-noise ratio of not greater than 15 dB, preferably not greater than 10 dB, further preferably not greater than 0 dB, is generated in the at least one region by means of the injected interference signal.

12. The method as claimed in claim 10 or 11, wherein before the step of: defining target output data during the processing of supplied training data, the hardware-based artificial neural network is trained (187) without injecting interference signals.

13. The method as claimed in any one of claims 10 to 12, wherein the at least one interference device is designed at least as claimed in claim 3 and the plurality of the actuatable interference elements are actuated in such a way that the interference signals form a predefined interference signal pattern over the hardware-based artificial neural network, wherein a plurality of training iterations of the hardware-Date: based artificial neural network are preferably carried out sequentially with different predefined interference signal patterns.

14. A method for training artificial neural networks in an arrangement as claimed in claim 8, wherein the method (188) for training an artificial neural network in an apparatus as claimed in any one of claims 10 to 13 is applied to the hardware-based artificial neural networks of the apparatuses, preferably after the apparatuses have been separately trained outside the arrangement by means of the method (180) as claimed in any one of claims 10 to 13.

15. A method (189) for training artificial neural networks in a system as claimed in claim 9, wherein the method (180) for training an artificial neural network in an apparatus as claimed in any one of claims 10 to 13 is applied to the hardware-based artificial neural networks of the apparatuses, preferably after the arrangements have been separately trained outside the system by means of the method (188) for training artificial neural networks in an arrangement as claimed in claim 14.
